(19) United States
(12) Patent Application Publication
(10) Pub. No.: US 2009/0121562 A1
(43) Pub. Date: May 14, 2009

(54) Device and method for cooling motor for hybrid electric vehicles

(75) Inventor: Jeong Bin Yim, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/006,367

(22) Filed: Dec. 31, 2007

(30) Foreign Application Priority Data
Nov. 9, 2007 (KR) 10-2007-0114214

(51) Int. Cl. H02K 9/193

(52) U.S. Cl. 310/54; 903/906

(57) ABSTRACT

The present invention provides a device for cooling a motor for hybrid electric vehicles, which comprises: an oil pump mounted on an outer surface of the motor housing in such a fashion as to be disposed coaxially relative to the shaft; a cooling oil supply line mounted in such a fashion as to be extended to an inner surface of the spider from an outlet of the oil pump; and a cooling oil return line mounted in such a fashion as to interconnect a bottom portion of the motor housing in which cooling oil is filled and an inlet of the oil pump.

### CROSS-REFERENCE TO RELATED APPLICATION

This application claims the benefit under 35 U.S.C. §119(a) of Korean Patent Application No. 10-2007-0114214 filed on Nov. 9, 2007, the entire contents of which are incorporated herein by reference.

### BACKGROUND

(a) Technical Field

The present invention relates to a device and a method for cooling a motor for hybrid electric vehicles. More particularly, the present invention relates to a device and a method for cooling a motor rotor for hybrid electric vehicles, in which cooling oil is supplied to a spider inside a motor using an oil pump to cause the cooling oil to flow into a rotor core, a stator core and a coil by a centrifugal force according to the rotation of a motor shaft to thereby smoothly cool the motor.

(b) Background Art

A hybrid electric vehicle (HEV) including a motor besides an engine as a driving source for driving the vehicle has been commercially released in the market as a future vehicle owing to the excellent fuel consumption ratio.

A motor mounted in the hybrid electric vehicle necessarily requires a cooling process. Since an air cooling system is insufficient for a motor with a power output of 15 to 20 kW or more, a water cooling system or a oil cooling system is used.

A motor with a power output of more than 15 to 20 kW for the hybrid electric vehicles, which is presently put on the market, employs both the oil cooling and water cooling systems, so that damage of coil coatings and irreversible demagnetization of a permanent magnet are prevented to thereby increase the output range of the motor.

Thus, in case of the motor with a power output of 15 to 20 kW or higher, cooling type or cooling efficiency are critical in the design of motors.

Now, the cooling type of a conventional motor for hybrid electric vehicles will be described in brief hereinafter.

FIG. 1 shows an example of a conventional cooling method of a motor for hybrid electric vehicles according to the prior art. Referring to FIG. 1, in a state where about a half of the lower portion of a stator inside a motor is submerged into cooling oil in the motor, the cooling oil is caused to flow toward the upper portion of the motor through pumping and the oil flows to a lower end of the stator by a gravity through a cooling oil passageway formed at the stator side. Such a conventional motor cooling type, however, entails a shortcoming in that although it can efficiently cool the stator, it cannot effectively cool the heat generated from a rotor or a permanent magnet by eddy current.

In another conventional motor cooling method, the lower portion (including the stator and the rotor) of the motor is submerged into cooling oil and the cooling oil is scattered while the rotor rotates to thereby cool the motor. However, this motor cooling method of submerging the rotor into the cooling oil encounters a problem in that a loss occurs during the rotation of the rotor due to resistance by the cooling oil, leading to a degradation of power efficiency of the motor.

FIG. 2 shows a further conventional cooling method of a motor for hybrid electric vehicles, as disclosed in Japanese Patent Laid-Open Publication No. Hei 2006-67777A. According to this method, cooling oil passageways are formed in a rotor so as to allow oil to be injected toward the internal cavity of the shaft, and the oil is scattered to the stator by a centrifugal force upon the rotation of the rotor. However, this method has a demerit in that the oil scattered from the rotor cools only a stator core, but does not positively cool a coil disposed at the upper and lower sides of the stator core, which directly contributes to heat emission, and in that the machining cost of the shaft and iron pieces is increased and the structure of the motor is complicated. Particularly, the motor disclosed in the Japanese reference is designed such that the rotor consists of the rotor and the rotor core only. For this reason, since there is a tendency that the quantity of iron pieces used in the core is increased, such a motor is disadvantageous in terms of cost. In addition, in case where the conventional motor includes a rotor consisting of a shaft, a spider and a rotor core, it has a structural difficulty in forming a cooling oil passageway so as to be extended up to the rotor core.

The information disclosed in this Background section is only for enhancement of understanding of the background of the invention and should not be taken as an acknowledgment or any form of suggestion that this information forms the prior art that is already known to a person skilled in that art.

### SUMMARY OF THE DISCLOSURE

The present invention has been made in an effort to solve the above problems occurring in the prior art, and it is an object of the present invention to provide a device and a method for cooling a motor for hybrid electric vehicles, in which cooling oil is supplied to a spider inside a motor using an oil pump to cause the cooling oil supplied to the spider to be scattered to a rotor core and simultaneously to flow up to a stator core and a coil wound around both ends of the stator core after passing through a permanent magnet to thereby cool respective heat-emitting parts of the motor.

In one aspect, the present invention provides a device for cooling a motor included in a motor housing of a hybrid electric vehicle. The motor housing also includes a shaft rotatably mounted at the inside center of the motor housing, a rotor core having a permanent magnet embedded therein, a spider for integrally interconnecting the shaft and the rotor core, a stator core disposed at the outer circumference of the rotor core and a coil wound around both ends of the stator. The device for cooling the motor comprises: an oil pump mounted on an outer surface of the motor housing in such a fashion as to be disposed coaxially relative to the shaft; a cooling oil supply line mounted in such a fashion as to be extended to an inner surface of the spider from an outlet of the oil pump; and a cooling oil return line mounted in such a fashion as to interconnect a bottom portion of the motor housing in which cooling oil is filled and an inlet of the oil pump.

In a preferred embodiment, the spider includes at least one first oil supply hole formed radially penetratingly therein (i.e., as shown in FIG. 3, the first oil supply hole is disposed perpendicular to the shaft 12), and the rotor core includes at least one second oil supply hole formed circumferentially penetratingly therein so as to communicate with the first oil supply hole.

In another preferred embodiment, the second oil supply hole is drilled axially at both distal ends thereof so that the cooling oil can be bypassed to and come into contact with the coil wound around the both ends of the stator core through the second oil supply hole.

In another aspect, there is provided a method of cooling a motor for hybrid electric vehicles. The method comprises the steps of: supplying cooling oil to an inner surface of a spider formed integrally with the outer circumference of a shaft centrally disposed inside a motor housing; externally scattering the cooling oil supplied to the inner surface of the spider by a centrifugal force according to the driving of the motor; and allowing the externally scattered cooling oil to flow to a rotor core having a permanent magnet embedded therein, a stator core and a coil wound around the stator core so as to cool the rotor core, the stator core and the coil.

The above features and advantages of the present invention will be apparent from or are set forth in more detail in the accompanying drawings, which are incorporated in and form a part of this specification, and the following Detailed Description, which together serve to explain by way of example the principles of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like.

### BRIEF DESCRIPTION OF THE DRAWINGS

FIGS. 1 and 2 are cross-sectional views showing a conventional cooling method of a motor for hybrid electric vehicles according to the prior art; and

FIG. 3 is a cross-sectional view showing a cooling type of a motor for hybrid electric vehicles according to a preferred embodiment of the present invention.

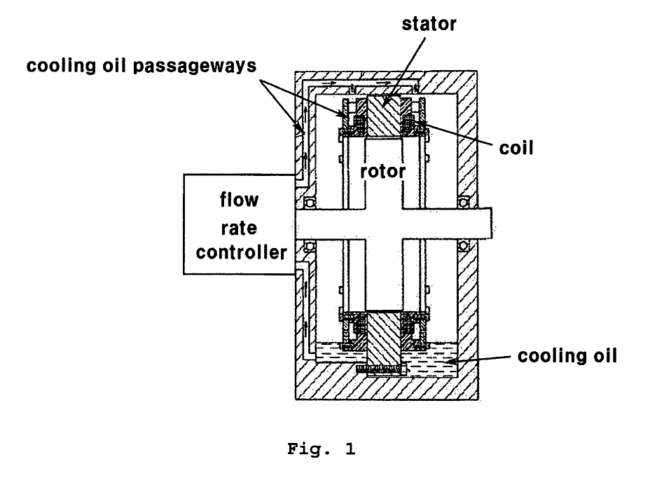

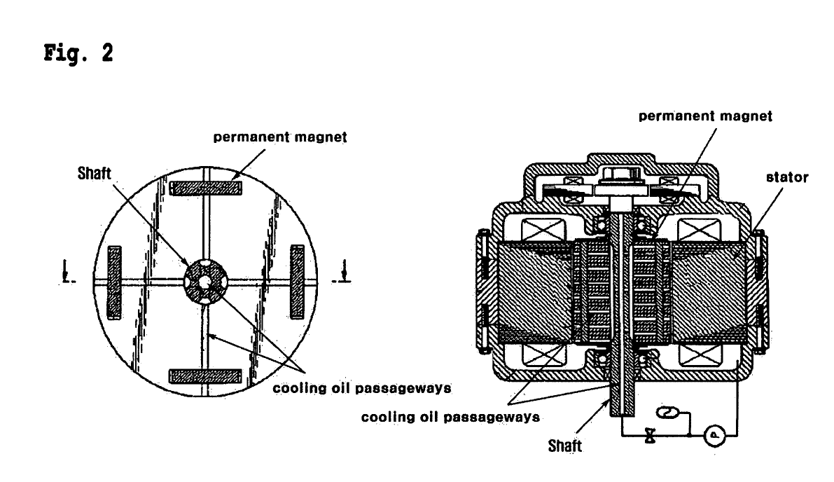

Reference numerals set forth in the Drawings includes reference to the following elements as further discussed below:
10: motor housing
12: shaft
14: permanent magnet
16: rotor core
18: spider
20: stator core
21: coil
22: cooling oil
24: oil pump
26: cooling oil supply line
28: cooling oil return line
30: first oil supply hole
32: second oil supply hole

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

The present invention is intended to cool a motor for hybrid electric vehicles (HEVs), and is designed based on the main idea that the inventive cooling type can easily cool a rotor core, a permanent magnet embedded in the rotor core, a stator core, and, particularly, a coil wound around the stator core, which are all disposed at the inner circumferential wall side of a motor housing, using a centrifugal force according to the driving of the motor.

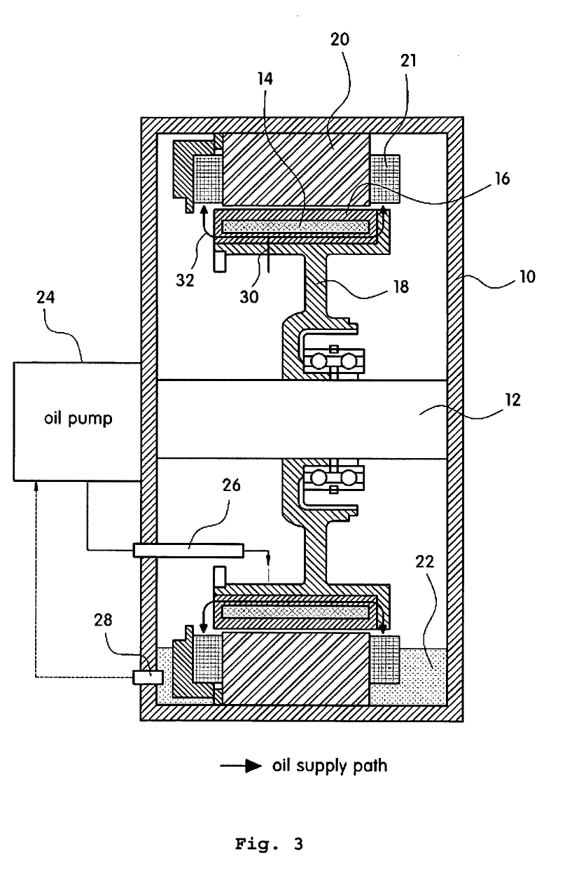

FIG. 3 is a cross-sectional view showing a cooling type of a motor for an HEV according to the present invention.

An HEV includes a motor housing 10, a shaft 12 rotatably mounted at the inside center of the motor housing 10, a rotor core 16 having a permanent magnet 14 embedded therein, a spider 18 for integrally interconnecting the shaft 12 and the rotor core 16, a stator core 20 disposed at the outer circumference of the rotor core 16 and a coil 21 wound around both ends of the stator core. The bottom portion of the motor housing 10 is filled with cooling oil 22, so that the stator core 20 and the coil 21 are submerged into the cooling coil 22.

The device for cooling the motor as constructed above features that an oil pump 24 is mounted on an outer surface of the motor housing 10 in such a fashion as to be disposed coaxially relative to the shaft 12, a cooling oil supply line 26 is mounted in such a fashion as to be extended to an inner surface of the spider 18 from an outlet of the oil pump 24, and a cooling oil return line 28 interconnects a bottom portion of the motor housing 10 in which cooling oil 22 is filled and an inlet of the oil pump 24.

Particularly, the spider 18 includes at least one first oil supply hole 30 formed radially penetratingly therein. The rotor core 16 includes at least one second oil supply hole 32 formed circumferentially penetratingly therein so as to communicate with the first oil supply hole 30. In this case, the second oil supply hole 32 is formed on a boundary surface between the rotor core 16 and the permanent magnet 14 embedded therein.

In addition, the second oil supply hole 32 is drilled axially at both distal ends of so that the cooling oil can be bypassed to and come into contact with the coil 21 wound around the both ends of the stator core 20 through the second oil supply hole.

The process of cooling the motor according of the present invention based on the device for cooling the motor as described above will now be described hereinafter.

When the oil pump 24 is driven along with the driving of the motor, cooling oil is supplied to an inner surface of the spider 18 from the outlet of the oil pump 24 via the cooling oil supply line 26.

The cooling oil supplied to the inner surface of the spider 18 is externally scattered by a centrifugal force according to the driving of the motor. At this time, the externally scattered cooling oil is supplied to the rotor core 16 through the first oil supply hole 30 of the spider 18, and subsequently is bypassed to the stator core 20 and the coil 22 wound around the stator core through the second oil supply hole 32 formed in the rotor core 16

More specifically, the cooling oil 22 filled in the bottom portion of the motor housing 10 is caused to flow to the inside of the spider 18 using the oil pump 24, so that the cooling oil is diffused to the entire spider 18 by the centrifugal force due to the rotation of the shaft according to the driving of the motor, and then flows into the second oil supply hole 32 as a cooling oil passageway of the rotor core 16 through the first oil supply hole 30 of the spider 18 to thereby cool the permanent magnet 14 embedded in the rotor core.

In this case, since the eddy-current loss of the permanent magnet 14 occurs at the outer corners of the permanent magnet, it is preferably to promote formation of a cooling coil passageway by utilizing an air gap (not shown) presently used in the rotor core structure. More preferably, the second oil supply hole 32 of the rotor core 16 is formed along a circumferential direction of the rotor core 16 in such a fashion as to be axially drilled at both distal ends thereof.

Therefore, when the cooling oil flows through the second oil supply hole 32 of the rotor core 16, it cools the permanent magnet 14, The cooling oil subsequently passes through the second oil supply hole 32 of the rotor core 16 so as to cool the coil where heat is emitted to the maximum while being scattered to the surrounding area.

Likewise, the motor cooling type of the prevent invention allows a cooling path to be formed through the rotor core so as to more effectively cool the permanent magnet from which heat is emitted as compared to the conventional motor cooling type to thereby prevent the irreversible demagnetization of a permanent magnet. Also, the present invention does not allow the rotor core to be directly submerged into the cool oil in the motor housing, so that there is no frictional resistance due to the cooling oil and the cooling oil scattered from the rotor core directly cools the coil where heat is emitted to the maximum, thereby enhancing cooling efficiency.

As described above, devices and methods for cooling a motor for hybrid electric vehicles according to the present invention provide advantageous effects including the following.

The present motor cooling devices and methods enable cooling oil to be supplied to the inside of the spider in the motor housing so that the cooling oil can evenly flow into the rotor core having permanent magnet embedded therein, the stator core and the coil wound around the stator core by a centrifugal force according to the driving of the motor to thereby easily cool respective parts in the motor.

Particularly, the cooling oil is smoothly supplied to the outer corners of the permanent magnet inside the rotor core where the eddy-current loss occurs intensively, and the coil of the stator core where heat is emitted to the maximum, thereby greatly increasing the cooling efficiency of the motor.

Furthermore, the present invention is advantageous in that since the shaft of the motor needs not to be drilled at the center thereof, the cooling oil can be easily supplied to the entire constituent parts of the motor by means of the centrifugal force and a cooling oil passageway can be easily formed in a spider structure used widely presently.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A device for cooling a motor for hybrid electric vehicles (HEVs), the motor including a motor housing, a shaft rotatably mounted at the inside center of the motor housing, a rotor core having a permanent magnet embedded therein, a spider for integrally interconnecting the shaft and the rotor core, a stator core disposed at the outer circumference of the rotor core and a coil wound around both ends of the stator, the device comprising:
an oil pump mounted on an outer surface of the motor housing in such a fashion as to be disposed coaxially relative to the shaft;
a cooling oil supply line mounted in such a fashion as to be extended to an inner surface of the spider from an outlet of the oil pump; and
a cooling oil return line mounted in such a fashion as to interconnect a bottom portion of the motor housing in which cooling oil is filled and an inlet of the oil pump.

2. The device of claim 1, wherein the spider includes at least one first oil supply hole formed radially penetratingly therein, and the rotor core includes at least one second oil supply hole formed circumferentially penetratingly therein so as to communicate with the first oil supply hole.

3. The device of claim 2, wherein the second oil supply hole is drilled axially at both distal ends of so that the cooling oil can be bypassed to and come into contact with the coil wound around the both ends of the stator core through the second oil supply hole.

4. A method of cooling a motor for hybrid electric vehicles, the method comprising the steps of:
supplying cooling oil to an inner surface of a spider formed integrally with the outer circumference of a shaft centrally disposed inside a motor housing;
externally scattering the cooling oil supplied to the inner surface of the spider by a centrifugal force according to the driving of the motor; and
allowing the externally scattered cooling oil to flow to a rotor core having a permanent magnet embedded therein, a stator core and a coil wound around the stator core so as to cool the rotor core, the stator core and the coil.
